(19) United States
(12) Patent Application Publication
(10) Pub. No.: US 2023/0221009 A1
(43) Pub. Date: Jul. 13, 2023

(54) INNER TRAY STRUCTURE OF OPEN FIRE OVEN

(71) Applicant: Hangzhou Yixiang Technology Research and Development Co., Ltd., Hangzhou (CN)

(72) Inventors: Yulin Ye, Hangzhou (CN); Xuejin Yang, Hangzhou (CN)

(21) Appl. No.: 17/685,360

(22) Filed: Mar. 2, 2022

(30) Foreign Application Priority Data
Jan. 11, 2022 (CN) 202220066318.X

(51) Int. Cl. F24C 15/14; A47J 37/07; F24B 13/00

(52) U.S. Cl. CPC F24C 15/14; A47J 37/0704; A47J 37/0786; F24B 13/008

(57) ABSTRACT

Disclosed is an inner tray structure of an open fire oven. The inner tray structure of an open fire oven includes an oven base; a grill, an oil drip tray and an ash cleaning tray are mounted on the oven base in turn from top to bottom; the ash cleaning tray is provided with holders, a top of one holder is provided with a handle, and the oil drip tray abuts on the holders; and other components. The oil drip tray and the ash cleaning tray can be taken out conveniently and quickly together, and charcoal ash and grease can be stored and separated in an oven as well.

### CROSS REFERENCE TO RELATED APPLICATIONS

The present application claims the benefit of Chinese Patent Application No. 202220066318.X filed on Jan. 11, 2022, the contents of which are incorporated herein by reference in their entirety.

### TECHNICAL FIELD

The present invention relates to the technical apparatus field of open fire ovens, and in particular to an inner tray structure of the open fire oven.

### BACKGROUND ART

An open fire oven is a kitchen utensil that produces open fire and charcoal fire by burning granular fuel, so as to cook food on a grill. Generally, for an outdoor large-scale open fire oven, a grill is generally arranged above a fire pan, while for a domestic/small open fire oven, an oil tray is generally arranged in an oven body to prevent oil, produced from food, from dripping directly on the open fire and charcoal fire.

An inner tray structure of the existing open fire oven is generally stacked layer by layer, thereby bringing troubles in disassembly and cleaning.

To this end, it is urgent to design an inner tray structure of an open fire oven that can solve one or more of the above problems.

### SUMMARY

To solve one or more problems existing in the prior art, the present invention provides an inner tray structure of an open fire oven. To solve the above problems, a technical solution used by the present invention is as follows: the inner tray structure of an open fire oven includes an oven base, where a grill, an oil drip tray and an ash cleaning tray are mounted on the oven base in turn from top to bottom;
the oil drip tray is provided with a through recess, open fire may spark out of the through recess, and the oil drip tray is provided with a fitting through recess; and
the ash cleaning tray is provided with holders, a top of one holder is provided with a handle, the oil drip tray abuts on the holders, the handle passes through the fitting through recess, the ash cleaning tray is provided with a fire through recess, and the fire through recess fits the through recess.

Further, the plurality of holders are arranged, and the top of at least one holder is provided with the handle.

Further, two holders are symmetrically arranged on the ash cleaning tray.

Further, the inner tray structure of an open fire oven includes an oil drip tank, where the oil drip tank is provided in the oven base and at a lower side of the ash cleaning tray; and

the oil drip tray is provided with a diversion recess, the diversion recess being in communication with an oil conduit, the oil conduit being in communication with the oil drip tank. Generally, the oil conduit passes through the ash cleaning tray to be in communication with the oil drip tray and the oil drip tank.

Further, a bottom surface of the oil drip tray is provided with a fire distribution plate, the fire distribution plate is provided with a fire distribution through recess, the fire distribution through recess fits the through recess and the fire through recess, and the fire distribution plate is arranged on an upper side of the ash cleaning tray.

Further, a section of the fire distribution plate is U-shaped.

Further, an edge of the oil drip tray is provided with a folded edge extending upwards, and an edge of the ash cleaning tray is provided with a folded edge extending upwards.

Further, an open fire regulator is mounted on the oil drip tray, the open fire regulator fitting the through recess, and being used for regulating the open fire sparking out of the through recess.

The present invention has benefits as follows: the oven base, the oil drip tray, the ash cleaning tray, the oil drip tank and other components are connected together by means of an ingenious structure, such that a tray in the oven base may be quickly and conveniently taken out by means of the handle, and excessive grease and charcoal ash may be prevented from being attached to hands; the fire distribution plate and the open fire regulator are arranged to facilitate open fire regulation by a user, and the fire distribution plate drives open fire into the oil drip tray softer; and collected grease may be conveniently taken out through the oil drip tank. The folded edge is arranged depend on the condition whether the tray is provided with a side wall for reliance, such that the tray forms a containing cavity by means of the folded edge, thereby collecting spread out charcoal ash and dripped grease. An overall structure is simple, stable and reliable, and is conducive to use and maintenance, thereby greatly improving use values of the present invention.

### BRIEF DESCRIPTION OF THE DRAWINGS

FIG. 1 is a mounting schematic diagram of the present invention;

FIG. 2 is an exploded view of the present invention; and

FIG. 3 is a schematic diagram of an oil drip tray of the present invention.

### REFERENCE NUMERALS

101·Oven base
401·Grill
410·Oil drip tray
411·Through recess
413·Diversion recess
414·Fitting through recess
415·Fire distribution plate
416·Fire distribution through recess
420·Ash cleaning tray
421·Holder
422·Handle
423·Fire through recess
430·Oil drip tank
431·Oil conduit
501·Open fire regulator

### DETAILED DESCRIPTION OF THE EMBODIMENTS

To make the above objectives, features and advantages of the present invention clearer and more comprehensible, specific embodiments of the present invention will be described in detail below with reference to the accompanying drawings. In the following description, numerous specific details are provided to fully understand the present invention. However, the present invention may be implemented in many other manners different from those described herein, and those skilled in the art may make similar improvements without violating the connotation of the present invention, so the present invention is not limited by the specific embodiments disclosed below.

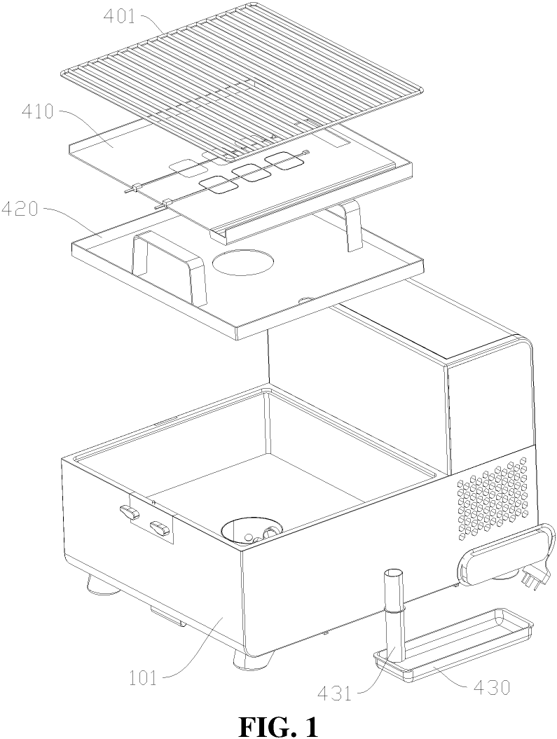

As shown in FIGS. 1-3, an inner tray structure of an open fire oven includes an oven base 101, where a grill 401, an oil drip tray 410 and an ash cleaning tray 420 are mounted on the oven base 101 in turn from top to bottom;
the oil drip tray 410 is provided with a through recess 411, open fire may spark out of the through recess 411, and the oil drip tray 410 is provided with a fitting through recess 414; and
the ash cleaning tray 420 is provided with holders 421, a top of one holder 421 is provided with a handle 422, the oil drip tray 410 abuts on the holders 421, the handle 422 passes through the fitting through recess 414, the ash cleaning tray 420 is provided with a fire through recess 423, and the fire through recess 423 fits the through recess 411.

It should be noted that a lower side of the fire through recess 423 of the ash cleaning tray 420 corresponds to a combustion furnace arranged in the oven base 101. When in use, the oil drip tray 410 and the ash cleaning tray 420 may be taken out together by means of the handle 422.

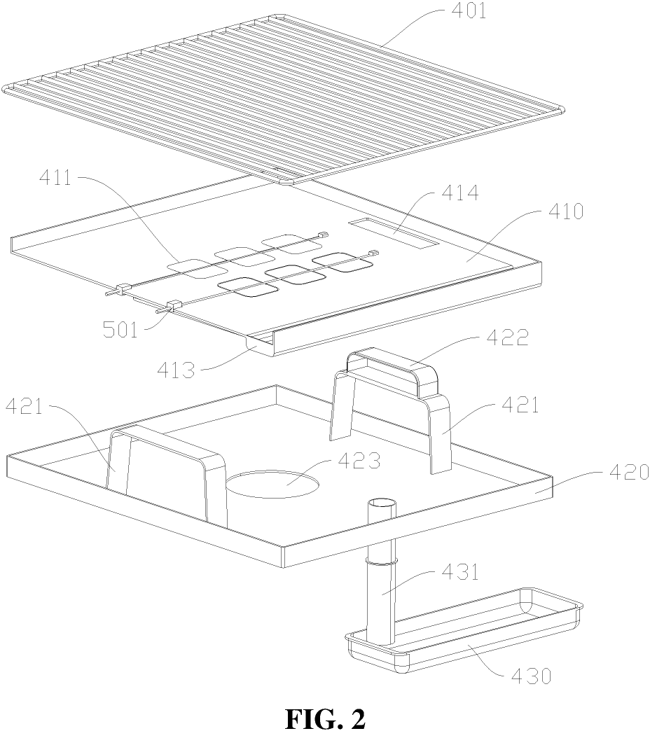

Specifically, as shown in FIG. 2, two holders 421 are symmetrically arranged on the ash cleaning tray 420, and one of the holders is provided with the handle 422, such that the oil drip tray 410 may be stably placed on the ash cleaning tray 420. Generally, a plurality of holders 421 may be arranged, and a top of at least one of the holders 421 is provided with the handle 422, so as to meet mounting requirements of trays with different shapes and sizes.

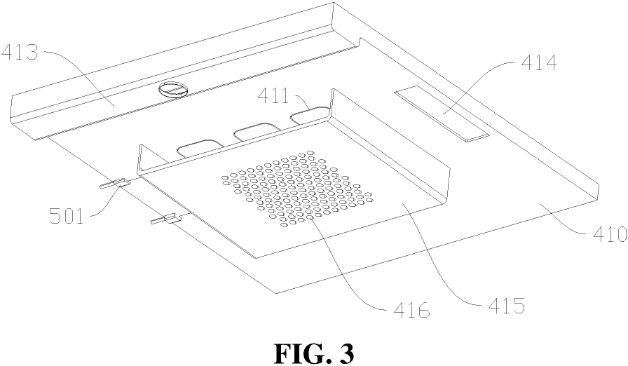

Specifically, as shown in FIG. 2 and FIG. 3, the inner tray structure of an open fire oven further includes an oil drip tank 430, where the oil drip tank 430 is provided in the oven base 101 and at a lower side of the ash cleaning tray 420.

The oil drip tray 410 is provided with a diversion recess 413, the diversion recess 413 being in communication with an oil conduit 431, the oil conduit 431 being in communication with the oil drip tank 430. Generally, the oil conduit 431 passes through the ash cleaning tray 420 to be in communication with the oil drip tray 410 and the oil drip tank 430. Generally, the oil conduit 431 may be mounted on the oil drip tank 430 or the oven base 101 or the oil drip tray 410 or the ash cleaning tray 420. To facilitate mounting and taking-out of components, the oil conduit 431 is linear. To conveniently take out the oil drip tank 430 for oil pouring, the oil conduit 431 may move upwards and downwards.

Specifically, as shown in FIG. 3, a bottom surface of the oil drip tray 410 is provided with a fire distribution plate 415, the fire distribution plate 415 is provided with fire distribution through recesses 416, a plurality of fire distribution through recesses 416 are provided, the fire distribution through recesses 416 fit the through recess 411 and the fire through recess 423, and the fire distribution plate 415 is arranged on an upper side of the ash cleaning tray 420. The fire distribution plate 415 and the oil drip tray 410 may be mounted integrally or separately. Generally, a section of the fire distribution plate 415 is U-shaped, and the fire distribution through recesses 416 are arranged in an array. By arranging the fire distribution plate 415, the overall open fire is softer, and large open fire is distributed into small open fire.

It should be noted that an edge of the oil drip tray 410 is provided with a folded edge extending upwards, and an edge of the ash cleaning tray 420 is provided with a folded edge extending upwards. The folded edge is arranged, such that the oil drip tray 410 and the ash cleaning tray 420 form storage spaces for storing grease and charcoal ash. The folded edge may be conveniently formed by means of a sheet metal process.

Specifically, as shown in FIG. 2 and FIG. 3, an open fire regulator 501 is mounted on the oil drip tray 410, the open fire regulator 501 fitting the through recess 411, and the open fire regulator 501 being used for regulating the open fire sparking out of the through recess 411. The open fire regulator 501 regulates the open fire by changing a degree of blocking the through recess 411.

To sum up, according to the present invention, the oven base 101, the oil drip tray 410, the ash cleaning tray 420, the oil drip tank 430 and other components are connected together by means of an ingenious structure, such that a tray in the oven base may be quickly and conveniently taken out by means of the handle, and excessive grease and charcoal ash may be prevented from being attached to hands; the fire distribution plate and the open fire regulator are arranged to facilitate open fire regulation by a user, and the fire distribution plate drives open fire into the oil drip tray softer; and collected grease may be conveniently taken out through the oil drip tank. The folded edge is arranged depend on the condition whether the tray is provided with a side wall for reliance, such that the tray forms a storage cavity through the folded edge, so as to store spread out charcoal ash and dripped grease. In addition, the sheet metal process for production is simpler. An overall structure is simple, stable and reliable, and is conducive to use and maintenance, thereby greatly improving use values of the present invention.

The embodiments above are merely one or more types of embodiments of the present invention, and are specifically described in details, but cannot be interpreted as limiting the patent for the present invention as a result. It shall be noted that for those of ordinary skill in the field, they may make several transformations and improvements on the premise without deviating from a concept of the present invention, such transformations and improvements shall be integrated as falling within the protection scope of the present invention. Hence, the protection scope of the present invention shall be subject to the appended claims.

What is claimed is:

1. An inner tray structure of an open fire oven, comprising: an oven base, wherein a grill, an oil drip tray and an ash cleaning tray are mounted on the oven base in turn from top to bottom;
the oil drip tray is provided with a through recess, open fire can spark out of the through recess, and the oil drip tray is provided with a fitting through recess; and
the ash cleaning tray is provided with holders, a top of one holder is provided with a handle, the oil drip tray abuts on the holders, the handle passes through the fitting through recess, the ash cleaning tray is provided with a fire through recess, and the fire through recess fits the through recess.

2. The inner tray structure of an open fire oven according to claim 1, wherein the plurality of holders are arranged, and the top of at least one holder is provided with the handle.

3. The inner tray structure of an open fire oven according to claim 1, wherein two holders are symmetrically arranged on the ash cleaning tray.

4. The inner tray structure of an open fire oven according to claim 1, further comprising: an oil drip tank, wherein the oil drip tank is provided in the oven base and at a lower side of the ash cleaning tray; and
the oil drip tray is provided with a diversion recess, the diversion recess being in communication with an oil conduit, the oil conduit being in communication with the oil drip tank.

5. The inner tray structure of an open fire oven according to claim 4, wherein the oil conduit passes through the ash cleaning tray to be in communication with the oil drip tray and the oil drip tank.

6. The inner tray structure of an open fire oven according to claim 1, wherein a bottom surface of the oil drip tray is provided with a fire distribution plate, the fire distribution plate is provided with a fire distribution through recess, the fire distribution through recess fits the through recess and the fire through recess, and the fire distribution plate is arranged on an upper side of the ash cleaning tray.

7. The inner tray structure of an open fire oven according to claim 6, wherein a section of the fire distribution plate is U-shaped.

8. The inner tray structure of an open fire oven according to claim 1, wherein an edge of the oil drip tray is provided with a folded edge extending upwards.

9. The inner tray structure of an open fire oven according to claim 1, wherein an edge of the ash cleaning tray is provided with a folded edge extending upwards.

10. The inner tray structure of an open fire oven according to claim 1, wherein an open fire regulator is mounted on the oil drip tray, the open fire regulator fitting the through recess, and the open fire regulator being used for regulating the open fire sparking out of the through recess.
